(19) United States
(12) Patent Application Publication
(10) Pub. No.: US 2023/0275205 A1
(43) Pub. Date: Aug. 31, 2023

(54) Lithium-ion polymer liquid automotive battery

(71) Applicant: REGEN TECHNOLOGIES PTE. LTD., Singapore (SG)

(72) Inventors: Haibiao Wang, Shanghai (CN); Benjamin Hock Beng Khoo, Singapore (SG)

(21) Appl. No.: 18/144,213

(22) Filed: May 7, 2023

(51) Int. Cl. H01M 4/04; H01M 10/0565; H01M 10/0525

(52) U.S. Cl. CPC H01M 4/0416; H01M 10/0565; H01M 10/0525; H01M 2220/20; H01M 2004/021

(57) ABSTRACT

A lithium-ion polymer liquid automotive battery includes: an internal cavity structure; an ionic membrane, separating the internal cavity structure into an upper layer and a lower layer, wherein the upper layer is a lithium metal electrode cavity structure and the lower layer is a lithium-oxygen reactant residual cavity structure; a solution, formed by mixing lithium polymer nanoparticle dry powder with lithium salt electrolyte, wherein the solution is injected into the lithium metal electrode cavity structure; a lithium metal electrode, mounted on the lithium metal electrode cavity structure; and a graphene porous carbon rod electrode, mounted on the lithium-oxygen reactant residual cavity structure. On all positive and negative plates of the liquid battery, there is no need for electrochemical reactions and thus no need to use the grid for charging. Instead, the reaction of lithium and oxygen ions can generate electric charges to drive the electric vehicle.

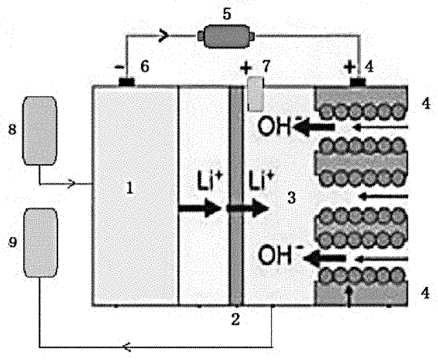

### BACKGROUND OF THE PRESENT INVENTION

### Field of Invention

The present invention relates to a technical field of liquid battery, and more particularly to a lithium-ion polymer liquid automotive battery.

### Description of Related Arts

As global oil reserves decline, the motivation to develop battery electric vehicle (an electric vehicle running solely on an electric vehicle battery) increases. As a consequence, improvements to the range and weight of electric vehicles become economically desirable.

There are many obstacles in developing a battery electric vehicle. One such obstacle is overcoming “range anxiety”. Range anxiety is the driver's fear that a vehicle has insufficient energy storage to cover the road distance needed to reach its intended destination, and would thus strand the vehicle's occupants mid-way. The term, which is now primarily used in reference to battery electric vehicles, is considered to be one of the major psychological barriers to large-scale public adoption of electric cars.

Actual range varies with driver operation and frequently has been found to be worryingly less than expected, especially in heavily populated areas where traffic speed is variable, while the demands on the battery from non-motive peripherals are constant (air conditioning, heating, lighting, etc.). This varying range prevents electric vehicle users from accurately planning the actual transportation range of their electric vehicles even if the users know the percentage that the electric battery is charged at the beginning of a trip.

In order to reduce range anxiety, attempts have been made to extend the range of the vehicle by increasing the amount of battery energy per vehicle. However, increasing the amount of battery energy per vehicle brings a problem of requiring a relatively long period of time for charging. In order to shorten the charging time, it is necessary to supply a large amount of electric power in a short period of time to electric vehicles.

### SUMMARY OF THE PRESENT INVENTION

An object of the present invention is to provide a lithium-ion polymer liquid automotive battery, making charging as fast as adding gasoline.

Accordingly, in order to accomplish the above objects, the present invention provides a lithium-ion polymer liquid automotive battery, comprising:
an internal cavity structure;
an ionic membrane, separating the internal cavity structure into an upper layer and a lower layer, wherein the upper layer is a lithium metal electrode cavity structure and the lower layer is a lithium-oxygen reactant residual cavity structure; both the upper layer and the lower layer are fitted with conduits and connected to a transfer pump;
a solution, formed by mixing lithium polymer nanoparticle dry powder with lithium salt electrolyte, wherein the solution is injected into the lithium metal electrode cavity structure through the conduits;
a lithium metal electrode, mounted on the lithium metal electrode cavity structure; and
a graphene porous carbon rod electrode, mounted on the lithium-oxygen reactant residual cavity structure and communicating with an external pure oxygen tank.

Preferably, the lithium polymer nanoparticle dry powder is formed by pure lithium metal powder, polyacrylonitrile, and porous silicon nanoparticles, which is soluble in the lithium salt electrolyte to form a suspension with an adjustable concentration and a conductivity of 8-11 mS/cm.

Preferably, the lithium-ion polymer liquid automotive battery further comprises: a first tank, wherein the solution is stored in the first tank before being injected into the lithium metal electrode cavity structure of the internal cavity structure by a micropower circulation pump.

Preferably, after being consumed, the solution is replenished externally to the first tank for battery charging.

Preferably, under an external electric field, lithium ions detach from the lithium polymer nanoparticle dry powder, pass through the ionic membrane, and enter the lower layer of the internal cavity structure to react with oxygen ions emerging from the graphene porous carbon rod electrode, so as to generate electric charges.

Preferably, the electric charges are collected by a copper charge collector mounted on the lithium-oxygen reactant residual cavity structure.

Preferably, the graphene porous carbon rod electrode is a round rod made of a graphene porous carbon material, which is filled with pure oxygen while being heated and maintained at a certain temperature.

Preferably, a lithium-oxygen reactant residual solution generated in the lithium-oxygen reactant residual cavity is sent to a second tank by a circulation pump for storage, and all of the lithium-oxygen reactant residual solution in the second tank is discharged for recycling when replenishing the solution.

Preferably, the second tank comprises a residual liquid recovery device to perform a reduction reaction on the lithium-oxygen reactant residual solution, so as to restore a lithium metal raw material and separates the lithium salt electrolyte.

Preferably, both the lithium metal electrode and the graphene porous carbon rod electrode are connected to one motor.

The lithium-ion polymer liquid automotive battery according to the present invention can be charged by injecting new liquid battery solution, just like adding gasoline. Usually, the already prepared battery dry powder (the lithium polymer nanoparticle dry powder) is put into the first tank mounted on an automobile, and then an appropriate amount of the lithium salt electrolyte is added and mixed to form the battery solution. The battery solution is then pumped into the lithium metal electrode cavity structure of the internal cavity structure of the liquid automotive battery. Under the external electric field, the lithium ions detach from the lithium polymer nanoparticle dry powder, pass through the ionic membrane, and enter the lower layer of the internal cavity structure to react with the oxygen ions emerging from the graphene porous carbon rod electrode, so as to generate electric charges of the liquid automotive battery.

These and other objectives, features, and advantages of the present invention will become apparent from the following detailed description, the accompanying drawings, and the appended claims.

### BRIEF DESCRIPTION OF THE DRAWINGS

FIGURE is a cross sectional view of a lithium-ion polymer liquid automotive battery.

### DETAILED DESCRIPTION OF THE PREFERRED EMBODIMENT

Referring to FIGURE, a lithium-ion polymer liquid automotive battery according to a preferred embodiment of the present invention is illustrated, comprising:
an internal cavity structure;
an ionic membrane 2, separating the internal cavity structure into an upper layer and a lower layer, wherein the upper layer is a lithium metal electrode cavity structure and the lower layer is a lithium-oxygen reactant residual cavity structure; both the upper layer and the lower layer are fitted with conduits and connected to a transfer pump;
a solution 1, formed by mixing lithium polymer nanoparticle dry powder with lithium salt electrolyte, wherein the solution 1 is injected into the lithium metal electrode cavity structure through the conduits;
a lithium metal electrode 6, mounted on the lithium metal electrode cavity structure; and
a graphene porous carbon rod electrode 4, mounted on the lithium-oxygen reactant residual cavity structure and communicating with an external pure oxygen tank.

On all positive and negative plates of the liquid battery, there is no need for electrochemical reactions and thus no need to use the grid for charging. Instead, the reaction of lithium and oxygen ions can generate electric charges to drive the electric vehicle.

Preferably, the lithium polymer nanoparticle dry powder is formed by pure lithium metal powder, polyacrylonitrile, and porous silicon nanoparticles, which is soluble in the lithium salt electrolyte to form a suspension with an adjustable concentration and a conductivity of 8-11 mS/cm.

Preferably, the lithium-ion polymer liquid automotive battery further comprises: a first tank 8, wherein the solution 1 is stored in the first tank 8 before being injected into the lithium metal electrode cavity structure of the internal cavity structure by a micropower circulation pump.

Preferably, after being consumed, the solution 1 is replenished externally to the first tank 8 for battery charging.

Preferably, under an external electric field, lithium ions detach from the lithium polymer nanoparticle dry powder, pass through the ionic membrane 2, and enter the lower layer of the internal cavity structure to react with oxygen ions emerging from the graphene porous carbon rod electrode 4, so as to generate electric charges.

Preferably, the electric charges are collected by a copper charge collector 7 mounted on the lithium-oxygen reactant residual cavity structure.

Preferably, the graphene porous carbon rod electrode 4 is a round rod made of a graphene porous carbon material, which is filled with pure oxygen while being heated and maintained at a certain temperature.

Preferably, a lithium-oxygen reactant residual solution 3 generated in the lithium-oxygen reactant residual cavity is sent to a second tank 9 by a circulation pump for storage, and all of the lithium-oxygen reactant residual solution 3 in the second tank 9 is discharged for recycling when replenishing the solution 1.

Preferably, the second tank 9 comprises a residual liquid recovery device to perform a reduction reaction on the lithium-oxygen reactant residual solution 3, so as to restore a lithium metal raw material and separates the lithium salt electrolyte.

The residual liquid recovery device can fully recover the lithium metal raw material and separate the lithium salt electrolyte, thereby re-synthesizing new battery solution for repeated use, with no limit number of cycles.

Preferably, both the lithium metal electrode 6 and the graphene porous carbon rod electrode 4 are connected to one motor 5.

The lithium-ion polymer liquid automotive battery according to the present invention can be charged by injecting new liquid battery solution, just like adding gasoline. Usually, the already prepared battery dry powder (the lithium polymer nanoparticle dry powder) is put into the first tank mounted on an automobile, and then an appropriate amount of the lithium salt electrolyte is added and mixed to form the battery solution. The battery solution is then pumped into the lithium metal electrode cavity structure of the internal cavity structure of the liquid automotive battery. Under the external electric field, the lithium ions detach from the lithium polymer nanoparticle dry powder, pass through the ionic membrane, and enter the lower layer of the internal cavity structure to react with the oxygen ions emerging from the graphene porous carbon rod electrode, so as to generate electric charges of the liquid automotive battery.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims, such as various materials for preparing the lithium-ion polymer of the liquid battery and methods for injecting the lithium-ion polymer into the liquid battery.

What is claimed is:

1. A lithium-ion polymer liquid automotive battery, comprising:
an internal cavity structure;
an ionic membrane (2), separating the internal cavity structure into an upper layer and a lower layer, wherein the upper layer is a lithium metal electrode cavity structure and the lower layer is a lithium-oxygen reactant residual cavity structure;
both the upper layer and the lower layer are fitted with conduits and connected to a transfer pump;
a solution (1), formed by mixing lithium polymer nanoparticle dry powder with lithium salt electrolyte, wherein the solution (1) is injected into the lithium metal electrode cavity structure through the conduits;
a lithium metal electrode (6), mounted on the lithium metal electrode cavity structure; and
a graphene porous carbon rod electrode (4), mounted on the lithium-oxygen reactant residual cavity structure and communicating with an external pure oxygen tank.

2. The lithium-ion polymer liquid automotive battery, as recited in claim 1, wherein the lithium polymer nanoparticle dry powder is formed by pure lithium metal powder, polyacrylonitrile, and porous silicon nanoparticles, which is soluble in the lithium salt electrolyte to form a suspension with an adjustable concentration and a conductivity of 8-11 mS/cm.

3. The lithium-ion polymer liquid automotive battery, as recited in claim 1, further comprising: a first tank (8), wherein the solution (1) is stored in the first tank (8) before being injected into the lithium metal electrode cavity structure of the internal cavity structure by a micropower circulation pump.

4. The lithium-ion polymer liquid automotive battery, as recited in claim 3, wherein after being consumed, the solution (1) is replenished externally to the first tank (8) for battery charging.

5. The lithium-ion polymer liquid automotive battery, as recited in claim 1, wherein under an external electric field, lithium ions detach from the lithium polymer nanoparticle dry powder, pass through the ionic membrane (2), and enter the lower layer of the internal cavity structure to react with oxygen ions emerging from the graphene porous carbon rod electrode (4), so as to generate electric charges.

6. The lithium-ion polymer liquid automotive battery, as recited in claim 5, wherein the electric charges are collected by a copper charge collector (7) mounted on the lithium-oxygen reactant residual cavity structure.

7. The lithium-ion polymer liquid automotive battery, as recited in claim 1, wherein the graphene porous carbon rod electrode (4) is a round rod made of a graphene porous carbon material, which is filled with pure oxygen while being heated and maintained at a certain temperature.

8. The lithium-ion polymer liquid automotive battery, as recited in claim 1, wherein a lithium-oxygen reactant residual solution (3) generated in the lithium-oxygen reactant residual cavity is sent to a second tank (9) by a circulation pump for storage, and all of the lithium-oxygen reactant residual solution (3) in the second tank (9) is discharged for recycling when replenishing the solution (1).

9. The lithium-ion polymer liquid automotive battery, as recited in claim 8, wherein the second tank (9) comprises a residual liquid recovery device to perform a reduction reaction on the lithium-oxygen reactant residual solution (3), so as to restore a lithium metal raw material and separates the lithium salt electrolyte.

10. The lithium-ion polymer liquid automotive battery, as recited in claim 1, wherein both the lithium metal electrode (6) and the graphene porous carbon rod electrode (4) are connected to one motor (5).
